(19) United States
(12) Patent Application Publication
(10) Pub. No.: US 2014/0217683 A1
(43) Pub. Date: Aug. 7, 2014

(54) TRIMMING FRAMEWORK, MANUFACTURING METHOD AND ASSOCIATED DEVICE

(71) Applicant: Filiberto Martinetto, Torino (IT)

(72) Inventor: Filiberto Martinetto, Torino (IT)

(73) Assignee: FILMAR S.R.L., Caselle Torinese (TO) (IT)

(21) Appl. No.: 14/124,532

(22) PCT Filed: Jun. 7, 2011
(86) PCT No.: PCT/IB2011/001342

§ 371 Date: Apr. 4, 2014

(51) Int. Cl. F16J 15/10; D06C 15/04; D06H 7/00; D06C 7/00

(52) U.S. Cl. CPC F16J 15/102; D06C 7/00; D06C 15/04; D06H 7/00; F16J 15/108
USPC 277/654; 28/165; 28/170

(57) ABSTRACT

A method for producing a gasket framework (10) includes creating a strip (50) having a warp (20) and a weft (30) obtained using a yarn (40) made of semi-rigid synthetic material and susceptible of being folded. The method also includes compressing a multiple points (P) of the yarn (40) made of synthetic material.

The present invention refers to a trimming/gasket framework, method of production and related device.

The present invention shall particularly, but not exclusively, refer to a gasket framework for vehicles comprising a shaped rubber extruded to the framework. However, gaskets incorporating the framework subject of the present invention may be equally used for doors for refrigerators etc.

Generally, woven frameworks, comprising a warp made of polyester material, and a weft made of a metal thread so as to form a strip, which is subsequently U-folded to be extruded together with the shaped rubber of the gasket, are known.

The latest regulations regarding environmental protection have lead to the gradual replacement of components that are difficult to dispose and, analogously, an easier disposal of the previously described frameworks has been required.

A gasket framework woven and comprising a warp, made of polyester material, and a weft made of synthetic material is known from EP 08001024.

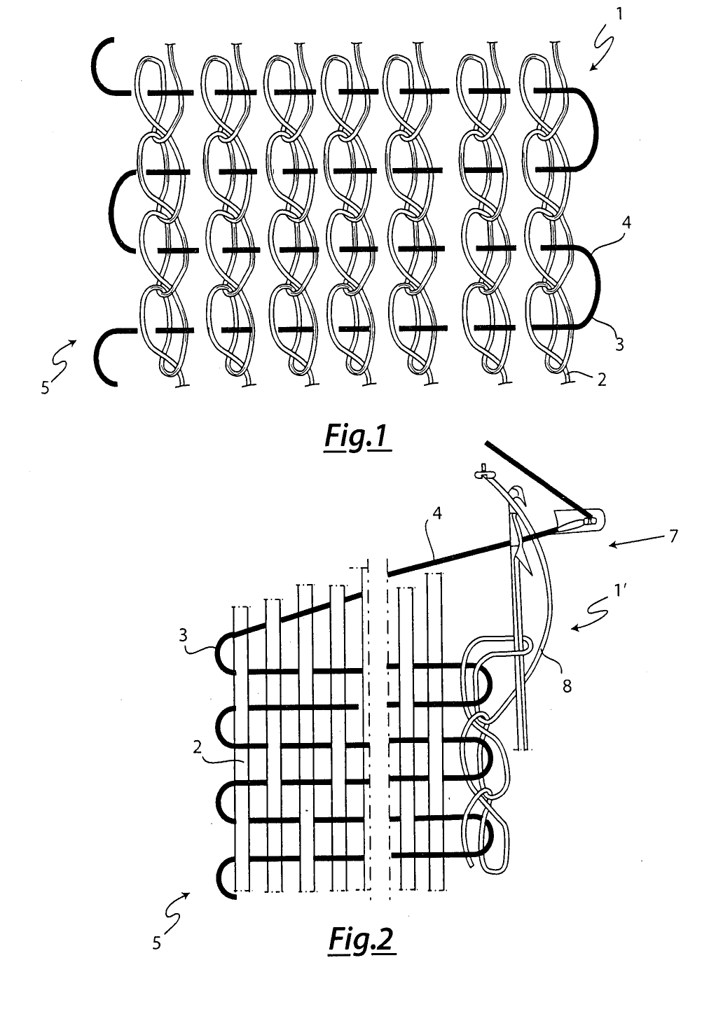

With reference to FIG. 1, framework 1 is woven and comprises a warp 2 made of polyester material and a weft 3 made using a yarn 4 made of synthetic material.

The framework is woven to form a strip 5 having a defined length L, and yarn 4 made of synthetic material is shaped to form a coil 6 having a width substantially equivalent to width L of strip 5.

Strip 5 is crocheted and has warp 2 knitted to yarn 4 made of synthetic material. Warp 2 has rows parallel to each other and to strip 5, and the number of rows as well as the mutual arrangement thereof, also depend on the structural requirements that framework 1 should have when being used.

FIG. 2 illustrates a variant of the framework 1, wherein strip 5 is woven on a needle loom, in which warp 2 is moved by heddles and it is formed by a plurality of threads parallel to each other and to strip 5, and yarn 4 made of synthetic material is weft by means of an underpick 7 with two-by-two wefts.

Furthermore strip 5 comprises a support thread 8 for binding yarn 4 made of synthetic material withheld, during weaving, by a needle.

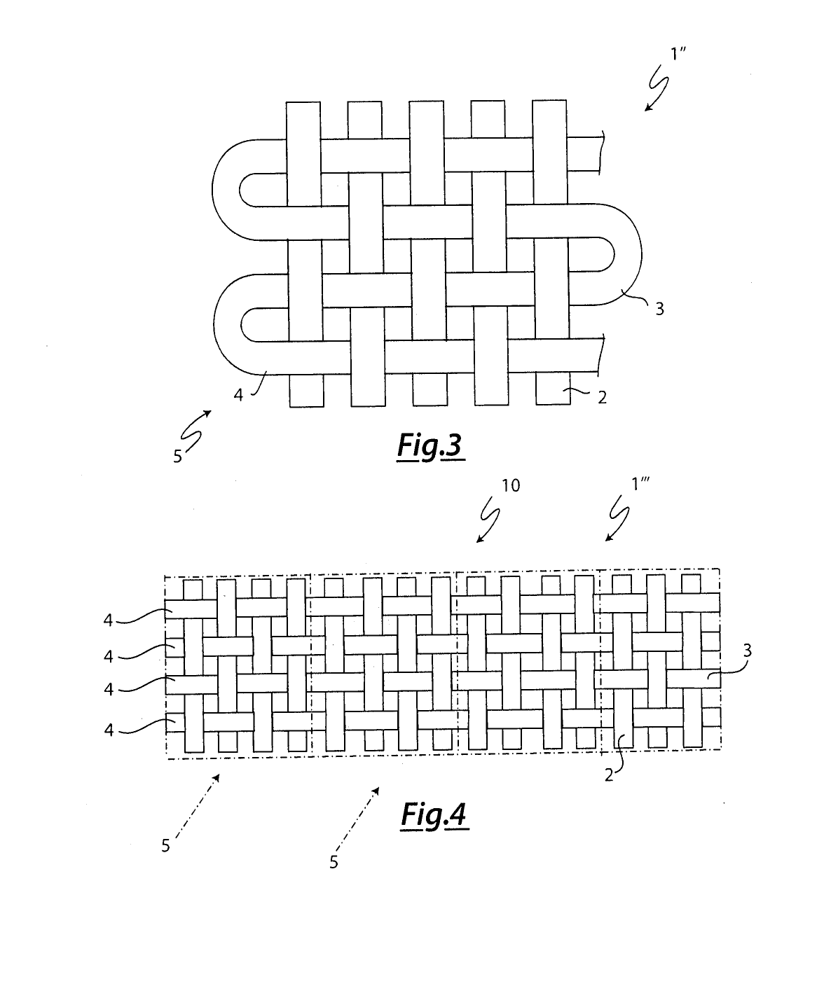

FIG. 3 illustrates a further variant of the known framework, wherein strip 5 is woven by means of a shuttle loom, i.e. warp 2 is moved by heddles and it is formed by a plurality of threads parallel to each other and to strip 5, while yarn 4 made of synthetic material is inserted by means of a shuttle, which—moving from left to right—inserts only one weft thread at a time.

Yarn 4 is made of a thread made of synthetic material, of the single thread or monofilament type.

Furthermore, in the previously described frameworks the use of a bonding agent can be provided for in order to integrally join warp 2 and weft 3 to each other with the aim of preventing mutual sliding.

FIG. 4 illustrates a framework with warp 2 made of polyester material and a weft 3 made using a yarn 4 made of synthetic material, and it is woven according to wide piece of fabric 10 on any type of loom instead of having weft 3 configured to form a coil 6 as previously described.

Fabric 10 is subsequently cut into strips or ribbons 5′, having a predetermined width and suitable for the use they are intended for.

However, the framework of the known type is difficult to handle during folding, often resulting in the obtained shape being not constant on the length of strip 5.

Thus, an object of the present invention is to describe a gasket framework which is free of the previously described drawbacks.

According to the present invention a method for producing gasket framework as claimed in claim 1 is described.

According to the present invention a gasket framework as claimed in claim eight is provided.

Finally, according to the present invention a device for producing frameworks for gaskets as claimed in claim sixteen is provided.

Now, the invention will be described with reference to the attached drawings, which illustrate a non-limiting example, wherein:

FIG. 1 illustrates a schematic view of a first gasket framework of the known type;

FIG. 2 illustrates a schematic view of a second gasket framework of the known type;

FIG. 3 illustrates a schematic view of a third gasket framework of the known type;

FIG. 4 illustrates a schematic view of a fourth gasket framework of the known type;

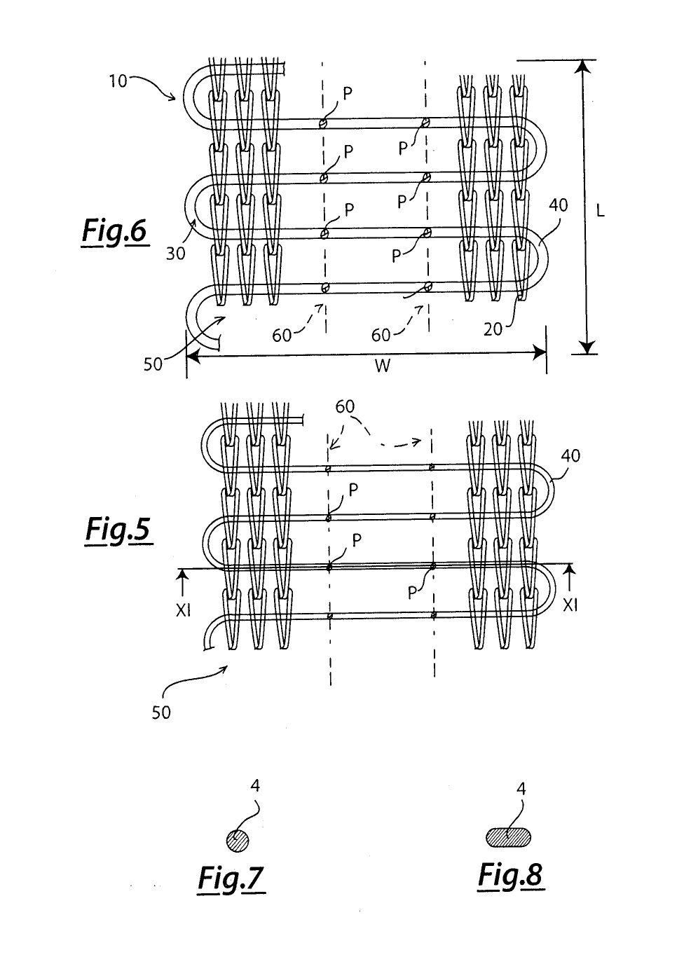

FIG. 5 and FIG. 6 illustrate respective schematic views of a gasket framework according to the present invention;

FIG. 7 and FIG. 8 illustrate a part of a yarn of the framework according to the present invention respectively before and after a calendering process;

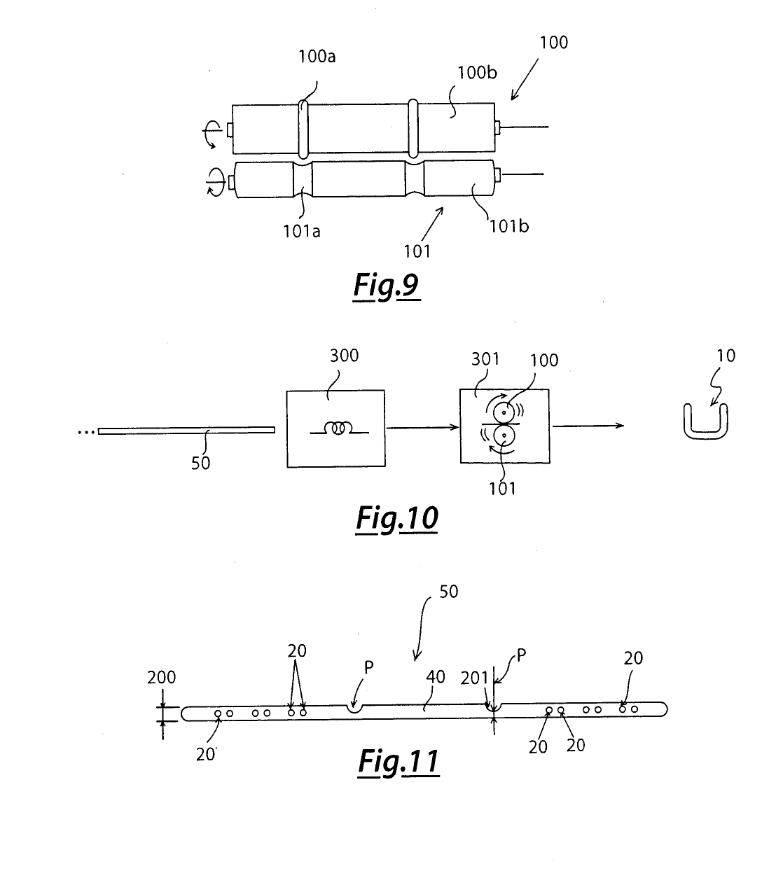

FIG. 9 illustrates part of a machine for producing the framework subject of the present invention;

FIG. 10 illustrates a schematic view of a machine for producing the framework subject of the present invention;

FIG. 11 illustrates a sectional view of FIG. 6 along lines XI-XI.

With reference to FIG. 5, a gasket framework is indicated in its entirety with 10. Framework 10 comprises a warp 20 made of polyester material and a weft 30 made using a yarn 40 made of semi-rigid synthetic material.

Framework 10 is woven to form a strip 50 having a length L, in which yarn 40 made of synthetic material is shaped to form a coil 45 whose width is substantially equivalent to a width w of strip 50.

Strip 50 can be crocheted, on a needle loom, i.e. in which warp 20 is moved by a plurality of needles and it is formed by a plurality of threads parallel to each other and to strip 50 and wherein yarn 40 made of synthetic material is weft by means of an underpick, or still as a wide piece.

Strip 50, at the end of the production thereof, is embedded in rubber or synthetic material (such as for example and not only limited to plastic) to form a rigid gasket susceptible of being applied on motor-vehicles or even on domestic appliances, though such two applications shall not be deemed restrictive in any manner whatsoever.

Yarn 40, as represented in FIGS. 5 and 7, can have a cylindrical section, dimensioned so as to be sufficiently resistant to traction or however to forces applied thereto depending on the use application.

However, strip 50, with yarn 40, having cylindrical section, is often too thick for the required application. Yarn 40 made of synthetic material is actually the element with largest diameter with respect to warp thread 20.

The alternative of reducing the diameter of yarn 40 must be excluded, given that reducing the diameter also implies reducing the mechanical resistance characteristics, which could lead to obtaining a gasket no longer meeting the design requirements.

Thus, yarn 40 is calendered, i.e. subjected to a compression process (typically by means of two rollers).

As illustrated in FIGS. 6 and 8, yarn 40 is thus made to acquire a compressed form, in which the section thereof has a first greater axis and a second smaller axis.

Observing strip 50 in plan view, i.e. in a direction orthogonal to the maximum length thereof, it should be observed that in the case of yarn 40 subjected to calendering, the first greater axis of the section of yarn 40 substantially lies on the plane of strip 50, hence appearing larger with respect to non-calendered yarn 40. Vice versa, the second smaller axis of the section of yarn 40 is oriented on a plane orthogonal to a plane of strip 50, hence the thickness of the latter is smaller with respect to the case in which yarn 40 is not subjected to calendering.

The advantage of using the calendering of yarn 40 and arranging it as illustrated above, is thus double and combined: the thickness of strip 50 is reduced and, simultaneously, the mechanical resistance characteristics of the yarn are maintained constant.

Yarn 40 is also compressed in a portion thereof; so as to be able to allow strip 50 a greater ease of the folding thereof to form a U-shape.

As illustrated in FIGS. 5 and 6, strip 50 has a yarn 40 made of synthetic material which is compressed into a plurality of points P, lying on a plurality of ideal lines 60 parallel to each other and also parallel to the direction of maximum extension of strip 50. The thickness of yarn 40 made of synthetic material is further reduced at points P, as illustrated in FIG. 11, by a first thickness 200 and a second thickness 201 smaller than the first thickness.

In detail, FIGS. 5 and 6 illustrate two ideal lines 60, for example susceptible to allow folding strip 50 to form a U-shape; however, the number of lines illustrated therein shall not be deemed restrictive in any manner whatsoever, given that there can for example be provided three ideal lines 60, still parallel to each other, useful for example for facilitating folding strip 50 to form an S-shape along the direction of maximum extension thereof.

Thus, the two ideal lines 60 define the lines along which strip 50 will be folded to form the U-shape concavity of the final shape thereof to be subsequently embedded in rubber.

In order to execute the plurality of compression points P, a machine for the production of strip 50 further comprises, besides the loom, also a compression stage 300 which in turn comprises a pair of rollers 100, 101 superimposed on each other and counter-rotating.

The pair of rollers 100, 101 comprises a first upper roller 100 and a second lower roller 101; the first upper roller 100 has a pair of annular elements 100a projecting with respect to a lateral surface 100b thereof; the second lower roller 101 has a pair of annular recesses 101a recessed with respect to a lateral surface 100b thereof.

In a production step, strip 50 is passed through a hole comprised between the first upper roller 100 and the second lower roller 101; through the combined action of annular elements 100a which counter with the annular recesses 100b (having a smaller recess depth with respect to the axial extension of the projections of annular elements 100a), yarn 40 is compressed along two lines, which are ideal lines 60.

The compression action is either hot or cold performed: in case of hot compression, the machine for producing strip 50, besides compression stage 300 (FIG. 10), further comprises a heating stage 301, arranged upstream of compression stage 300; such heating stage 301 has heating means, preferably electrical, specifically designed for heating strip 50 (typically, but not exclusively, at a temperature of about 180°). In this way, yarn 40 can be softened to facilitate compression thereof.

Other systems for providing points P are not excluded; for example points P can be alternatively provided through cutting by means of a laser device. In this case, compression stage 300 is equivalently replaced by a cutting stage 300′, in which the laser slightly cuts yarn 40 made of synthetic material, maintaining as much as possible—the mechanical resistance unaltered. Also in this case, at cutting points P, yarn 40 made of synthetic material assumes a second thickness 201 lower than the first thickness 200.

Using cutting stage 300′, the heating of strip 50 is also automatically carried out; however, the step of heating the strip occurs simultaneously with the cutting step.

The advantages of the framework subject of the present invention are known in the light of the description above. In particular, it is easier to fold, so as to allow taking on for example but not exclusively a U or S shape to be subsequently coated with rubber or plastic and thus, upon completing the creation of end gasket 10, coupled to the body of a motor-vehicle. The step of reducing the localised thickness of yarn 40, which, as described, can be a cutting or compression step, allows facilitating folding thereof.

Furthermore, the framework subject of the present invention is easier to fold; this result in the possibility of providing large amounts of strip 50 on a flat reel, then allowing the U-shaped folding even later.

The invention here described can be subjected to various additional variants and embodiments, obvious to a man skilled in the art, without departing from the scope of protection outlined by the attached claims.

1. Method for producing a gasket framework, comprising:
a step of creating a strip comprising a warp and a weft obtained using a yarn made of semi-rigid synthetic material and susceptible of being folded;
a step of localizing thickness reduction and facilitating folding of said yarn into a plurality of points of said yarn made of synthetic material; said plurality of points lying on a plurality of ideal parallel lines.

2. The method according to claim 1, wherein said step of localizing thickness reduction is a step; said compressing step comprises passing said strip between a pair of rollers respectively having a pair of projecting elements and a pair of recessed elements with respect to a lateral surface of said rollers.

3. The method according to claim 1, further comprising a step of heating said strip.

4. The method according to claim 3, wherein said step of heating said strip performs an action of softening said yarn made of synthetic material.

5. The method according to claim 1, wherein said thickness reduction step is a cutting step; said cutting step comprising a localised cutting of said yarn into a plurality of cutting points.

6. The method according to claim 1, wherein said yarn comprises a first thickness and in said plurality of points said yarn has a second thickness less than said first thickness.

7. The method according to claim 1, wherein said strip is U-folded at said plurality of points.

8. Gasket framework, comprising: a strip, the strip comprising a warp and a weft made using a yarn made of synthetic material; said yarn made of synthetic material comprises a plurality of compression or cutting points and said yarn is semi-rigid and susceptible of being folded; said plurality of points lying on a plurality of ideal parallel lines.

9. The gasket framework according to claim 8, wherein said yarn has a first thickness and wherein at said plurality of compression points said yarn has a second thickness less than said first thickness.

10. The gasket framework according to claim 9, wherein said points are points for the U-shaped folding or S-shaped folding of said strip.

11. Framework according to claim 8, wherein said yarn made of synthetic material is shaped to form a coil with width equivalent to a width of said strip.

12. Framework according to claim 8, wherein said yarn made of synthetic material has a cylindrical section.

13. Framework according to claim 8, wherein said yarn is calendered and comprises a section having a first greater axis and a second smaller axis.

14. Framework according to claim 13, wherein said first greater axis lies on a plane on which said strip lies, and wherein said smaller axis is oriented on an orthogonal plane with respect to a plane on which said strip lies.

15. Framework according to claim 8, wherein said ideal parallel lines are parallel to a direction of maximum extension of the strip.

16. Device for producing a gasket framework according to claim 8; said device comprising a loom and a thickness reduction stage, said thickness reduction stage comprising means for the localised reducing of the thickness of a yarn made of synthetic material, configured for reducing the thickness of said yarn along a plurality of ideal parallel lines.

17. Device according to claim 16, wherein said thickness reduction stage is a compression stage and comprises a pair of superimposed and counter-rotating rollers; said pair of rollers comprising a first roller provided with a pair of annular elements projecting with respect to a lateral surface of the first roller.
